(19) United States
(12) Patent Application Publication
(10) Pub. No.: US 2013/0324678 A1
(43) Pub. Date: Dec. 5, 2013

(54) METHOD FOR IMPROVING REJECTION OF PERMEABLE MEMBRANE, TREATMENT AGENT FOR IMPROVING REJECTION, AND PERMEABLE MEMBRANE

(71) Applicants: Takahiro Kawakatsu, Tokyo (JP); Tetsuya Aoki, Tokyo (JP)

(72) Inventors: Takahiro Kawakatsu, Tokyo (JP); Tetsuya Aoki, Tokyo (JP)

(73) Assignee: KURITA WATER INDUSTRIES LTD, Tokyo (JP)

(21) Appl. No.: 13/985,682

(22) PCT Filed: Mar. 5, 2012
(86) PCT No.: PCT/JP2012/055550

§ 371 Date: Aug. 15, 2013

(30) Foreign Application Priority Data
Mar. 9, 2011 (JP) 2011-051525

(51) Int. Cl. B01D 67/00

(52) U.S. Cl. CPC B01D 67/0097
USPC 525/432; 560/41

(57) ABSTRACT

Provide is a method capable of effectively improving a rejection of a permeable membrane without remarkably reducing a permeation flux, even if the membrane is seriously degraded. The method for improving a rejection of a permeable membrane supplies an aqueous solution (excluding an aqueous solution having a pH of 7 or less) containing a compound having an amino group and a molecular weight of 1,000 or less through the permeable membrane (amino-treatment step). Since the low molecular weight amino compound is supplied through the permeable membrane, degraded portions of the membrane can be restored without remarkably reducing the permeation flux thereof, and the rejection thereof can be effectively improved.

### FIELD OF INVENTION

The present invention relates to a method for improving a rejection of a permeable membrane and specifically relates to a method for restoring a permeable membrane, in particular, a degraded reverse osmosis (RO) membrane, to effectively improve the rejection thereof without remarkably reducing a permeation flux of the permeable membrane.

The present invention also relates to a permeable membrane treated by a rejection improving treatment using the method for improving a rejection of a permeable membrane and a treatment agent for improving a rejection to be used in this method.

### BACKGROUND OF INVENTION

RO membranes have been used in ultrapure water production plants, wastewater recovery plants, seawater desalination plants, and the like and can remove most of organic substances, inorganic substances, and the like contained in water.

The rejection of a permeable membrane, including an RO membrane, to substances to be removed, such as inorganic electrolytes and water soluble organic substances, is decreased by degradation of a high molecular weight base material due to influences of oxidizing substances, reducing substances, and the like present in water and other causes, and as a result, required treated water quality may not be obtained in some cases. This degradation may gradually occur during long-term use or may suddenly occur by an accident in some cases. In addition, in some cases, the rejection itself of the permeable membrane may not satisfy a level required as a product.

In a permeable membrane system using an RO membrane or the like, in order to prevent biofouling caused by slime on a membrane surface, a raw water treatment is performed in a pre-treatment step using chlorine (such as sodium hypochlorite). However, since chlorine has a strong oxidizing action, if water containing residual chlorine at a high concentration is supplied to a permeable membrane, the permeable membrane is degraded.

In order to decompose residual chlorine in water to be treated, a reducing agent, such as sodium bisulfite, may be added to the water in some cases. However, when a metal, such as Cu and/or Co, is contained in the water to be treated, even if a large amount of sodium bisulfite is added to the water, an RO membrane is degraded (Patent Document 1 and Non-Patent Document 1). When the permeable membrane is degraded, the rejection thereof is decreased.

Heretofore, as a method for improving the rejection of a permeable membrane such as an RO membrane, the following have been proposed.

i) A method for improving the rejection of a permeable membrane by adhesion of an anionic or a cationic high molecular weight compound to a membrane surface has been disclosed (Patent Document 2).

In the method described above, an effect of improving the rejection of a degraded membrane is not sufficient.

ii) A method for improving the rejection of a nanofiltration membrane or an RO membrane by adhesion of a compound having a poly(alkylene glycol) chain to a membrane surface has been disclosed (Patent Document 3).

This method is also not a method which sufficiently improves the rejection of a degraded membrane without remarkably reducing a permeation flux.

iii) A method for preventing membrane contamination and/or degradation in quality of permeated water has been disclosed in which a treatment using a nonionic surfactant is performed on a nanofiltration membrane or an RO membrane having an increased permeation flux and an anionic charge to reduce the permeation flux to an appropriate range (Patent Document 4). In this method, the nonionic surfactant is brought into contact with and is adhered to a membrane surface so as to set the permeation flux to a range of +20% to −20% of that at the start of use.

In order to improve the rejection of a seriously degraded membrane (membrane having a salt rejection decreased to 95% or less) by this method, a considerable amount of the surfactant is required to be adhered to the membrane surface, and as a result, a remarkable decrease in permeation flux may occur in some cases. One example of the above Patent Document 4 has disclosed that an aromatic polyamide RO membrane having a permeation flux of 1.20 m³/m²·day, a NaCl rejection of 99.7%, and a silica rejection of 99.5% as the initial performance at a production stage is used for 2 years, and the membrane thus obtained is used as an oxidation degraded membrane. In Patent Document 4, a membrane having a NaCl rejection of 99.5% and a silica rejection of 98.0%, which is not so much degraded, is used as an object, and it has not been disclosed that by the method described above, the rejection of a degraded permeable membrane is sufficiently improved.

iv) A method for improving the salt rejection by adhesion of a tannic acid or the like to a degraded membrane has been disclosed (Non-Patent Document 2).

However, an effect of improving the rejection obtained by this method is not significant. For example, even when the salt rejection of a degraded RO membrane, ES20 (manufactured by Nitto Denko Corp.) or SUL-G20F (manufactured by Toray Industries, Inc.), is improved by this method, a solute concentration of permeated water through the membrane after the improvement cannot be decreased to ½ of that of permeated water through the membrane before the improvement.

v) A method for improving the rejection of an RO membrane by addition of a poly(vinyl methyl ether) (PVME) to a tannic acid has been disclosed (Non-Patent Document 5). In this method, the concentration of the chemical agent to be used is relatively high, such as 10 ppm or more. In addition, when the membrane is treated by this method, the permeation flux of the membrane is decreased by approximately 20%. Furthermore, the rejection may be hardly improved in some cases.

Non-Patent Documents 3 and 4 have disclosed that in a polyamide membrane degraded by an oxidizing agent, the C—N bond of the polyamide linkage of a membrane base material is broken, and hence an inherent sieve structure of the membrane is destroyed.

The related rejection improving methods described above have the following problems a to c.

a) Since a substance is newly adhered to the surface of the permeable membrane, the permeation flux thereof is reduced. For example, when a degraded membrane is treated by a rejection improving treatment so that the solute concentration of water permeated through the membrane which is treated by a rejection recovery treatment is decreased to ½ of that of water permeated through the membrane which is not yet treated by the recovery treatment, in some cases, the permeation flux may be considerably decreased by 20% or more as compared to that before the treatment is performed.

b) When a chemical agent at a high concentration is added, TOC of brine separated by the membrane is increased. In addition, it is not easy to restore the membrane while water to be treated is supplied through the membrane and is collected.

c) For a membrane which is seriously degraded, the rejection thereof is not easily recovered.

### CITATION LIST

### Patent Document

Patent Document 1: Japanese Patent Publication 7-308671A

Patent Document 2: Japanese Patent Publication 2006-110520A

Patent Document 3: Japanese Patent Publication 2007-289922A

Patent Document 4: Japanese Patent Publication 2008-86945A

### Non-Patent Document

Non-Patent Document 1: Nagai et al., Desalination, Vol. 96 (1994), 291-301

Non-Patent Document 2: Satoh and Tamura, Kagaku Kogaku Ronbunnshu Vol. 34 (2008), 493-498

Non-Patent Document 3: Uemura et al., Bulletin of the Society of Sea Water Science, Japan, 57, 498-507 (2003)

Non-Patent Document 4: Yoshiyasu Kamiyama, Hyomen (Surface), Vol. 31, No. 5 (1993), 408-418

Non-Patent Document 5: S. T. Mitrouli, A. J. Karabelas, N. P. Isaias, D. C. Sioutopoulos, and A. S. Al Rammah, Reverse Osmosis Membrane Treatment Improves Salt-Rejection Performance, IDA Journal I Second Quarter 2010, p 22-34

### OBJECT AND SUMMARY OF INVENTION

An object of the present invention is to solve the related problems described above and is to provide a method capable of effectively improving a rejection of a membrane, even if the membrane is seriously degraded, without remarkably reducing a permeation flux, and a treatment agent used for the method described above.

Another object of the present invention is to provide a permeable membrane treated by a rejection improving treatment using the method for improving a rejection of a permeable membrane as described above.

In order to accomplish the above objects, intensive investigation was carried out by the present inventors through repeatedly performed examination and analysis of degraded membranes using actual machines, and finally the following findings were obtained.

1) In the conventional method in which a hole formed in a membrane by degradation thereof is filled up by adhesion of a new substance (such as a compound including a nonionic surfactant or a cationic surfactant) to the membrane, the permeation flux of the membrane is remarkably reduced because of hydrophobization of the membrane and adhesion of a high molecular weight compound thereto, and hence, it is difficult to secure the amount of water.

2) In a permeable membrane, such as a polyamide membrane, the C—N bond of the polyamide is broken by degradation caused by an oxidizing agent, and the inherent sieve structure of the membrane is destroyed; however, at degraded portions of the membrane, although the amide groups are lost by the breakage of the amide linkages, some carboxyl groups remain.

3) When an amino compound is made to be efficiently adhered and bonded to this carboxyl group of the degraded membrane, the degraded membrane is restored, and hence the rejection thereof can be recovered. As the amino compound to be bonded to the carboxyl group, when a low molecular weight compound having an amino group is used, remarkable reduction in permeation flux caused by hydrophobization of a membrane surface and adhesion of a high molecular weight compound thereto can be suppressed.

The present invention has been completed based on the findings as described above.

The method for improving a rejection of a permeable membrane of the present invention includes a step of passing an aqueous solution (excluding an aqueous solution having a pH of 7 or less) containing a compound having an amino group and a molecular weight of 1,000 or less through the permeable membrane.

The compound having an amino group may be a basic amino acid.

The compound having an amino group may be aspartame or a derivative thereof.

The aqueous solution may further contain a compound having a molecular weight of 1,000 to 10,000 and having a carboxyl group, an amino group, or a hydroxyl group.

The compound having a molecular weight of 1,000 to 10,000 and having a carboxyl group, an amino group, or a hydroxyl group may be a polymer of a tannic acid or an amino acid.

The concentration of each component of each compound contained in the aqueous solution is preferably 10 mg/L or less.

The permeable membrane of the present invention is treated by a rejection improving treatment using the method for improving a rejection of a permeable membrane described above.

The treatment agent for improving a rejection of a permeable membrane of the present invention includes: at least one compound having a molecular weight of 1,000 or less and having an amino group; and at least one compound having a molecular weight of 1,000 to 10,000 and having a carboxyl group, an amino group, or a hydroxyl group.

### Advantageous Effects of Invention

According to the present invention, when an aqueous solution (excluding an aqueous solution having a pH of 7 or less) containing a compound having an amino group and a molecular weight of 1,000 or less (hereinafter referred to as “low molecular weight amino compound”) is passed through a permeable membrane degraded by an oxidizing agent or the like, without remarkably reducing a permeation flux of this permeable membrane, degraded portions of the membrane can be restored, and hence the rejection thereof can be effectively improved.

Hereinafter, a mechanism of restoring a degraded membrane by the present invention will be described with reference to FIG. 1.

A permeable membrane, such as a polyamide membrane having a normal amide linkage, has the structure as represented by a normal membrane shown in FIG. 1. When this membrane is degraded by an oxidizing agent, such as chlorine, the C—N bond of the amide linkage is broken, and finally, the structure as shown by a degraded membrane in FIG. 1 is formed.

As shown by the degraded membrane in FIG. 1, although the amino group may be lost in some cases by the breakage of the amide linkage, a carboxyl group is formed on at least part of this breakage portion.

When a low molecular weight amino compound (such as 2,4-diamino benzoic acid) is contained in the degraded membrane as described above, an electrostatic bond is formed between the amino group of the low molecular weight amino compound and the carboxyl group of the membrane, and as shown by a treated membrane shown in FIG. 1, the low molecular weight amino compound is bonded to the membrane to form an insoluble salt. Hence, by this insoluble salt, holes of the degraded membrane are restored, and the rejection thereof is recovered.

When the low molecular weight amino compound is allowed to pass through the membrane, several types of amino compounds having different molecular weights and skeletons (structures) may be used in combination so as to simultaneously pass through the membrane, whereby the amino compounds described above interfere with each other when passing through the membrane, and as a result, residence time of the amino compounds at degraded portions in the membrane becomes long. Accordingly, the contact probability between the carboxyl group of the membrane and the amino group of the low molecular weight amino compound is increased, and hence, efficiency of restoring the membrane is increased.

In particular, when a high molecular weight compound is also used in combination, a large degraded portion of the membrane can be filled up, and the restoring efficiency is increased. The high molecular weight compound may be a compound having a functional group (cationic group: a primary to a tertiary amino group) which interacts with the carboxyl group of the membrane, a compound having a functional group (anionic group: a carboxyl group or a sulfonic group) which interacts with the compound having an amino group added as described above, a compound having a functional group (a hydroxyl group) which interacts with the polyamide membrane, or a compound having a cyclic structure.

### BRIEF DESCRIPTION OF DRAWINGS

FIG. 1 includes chemical structure formulas illustrating a mechanism of a rejection improving treatment of the present invention.

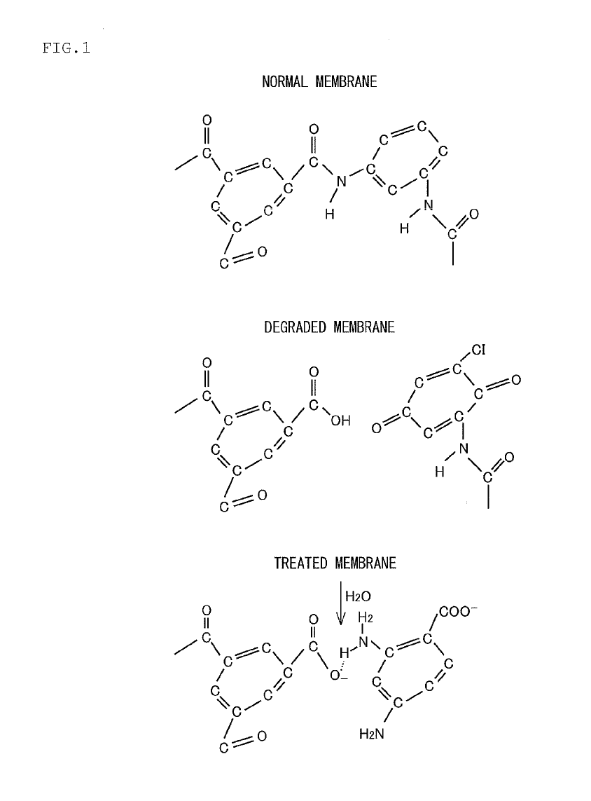

FIG. 2 is a schematic view showing a flat membrane test device used in Examples.

### DESCRIPTION OF EMBODIMENTS

Hereinafter, embodiments of the present invention will be described in detail.

[Method for Improving Rejection of Permeable Membrane]

A method for improving a rejection of a permeable membrane of the present invention includes an amino-treatment step of passing an aqueous solution (amino-treatment solution; excluding an aqueous solution having a pH of 7 or less) containing a low molecular weight amino compound of a molecular weight of 1,000 or less through the permeable membrane.

<Amino-Treatment Step>

In the present invention, the amino compound used in the amino-treatment step has an amino group and a relatively low molecular weight of 1,000 or less, and although the amino compound is not particularly limited, the following may be mentioned by way of example.

Aromatic amino compounds: Compounds having a benzene skeleton and an amino group, such as aniline (molecular weight: 93) and diamino benzene (molecular weight: 108).

Aromatic amino carboxylic acid compounds: Compounds having a benzene skeleton, at least two amino groups, and at least one carboxyl group, the number of which is smaller than that of the amino groups, such as 3,5-diamino benzoic acid (molecular weight: 152), 3,4-diamino benzoic acid (molecular weight: 152), 2,4-diamino benzoic acid (molecular weight: 152), 2,5-diamino benzoic acid (molecular weight: 152), and 2,4,6-triamino benzoic acid (molecular weight: 167).

Aliphatic amino compounds: Compounds having a linear hydrocarbon group of approximately 1 to 20 carbon atoms and at least one amino group, such as methylamine (molecular weight: 31), ethylamine (molecular weight: 45), octylamine (molecular weight: 129), and 1,9-diaminononane (in this specification, abbreviated as “NMDA” in some cases) (C₉H₁₈(NH₂)₂) (molecular weight: 158), and compounds each having a branched hydrocarbon group of approximately 1 to 20 carbon atoms and at least one amino group, such as aminopentane (in this specification, abbreviated as “IAAM” in some cases) (NH₂(CH₂)₂CH(CH₃)₂) (molecular weight: 87) and 2-methyloctanediamine (in this specification, abbreviated as “MODA” in some cases) (NH₂CH₂CH(CH₃)(CH₂)₆NH₂) (molecular weight: 158).

Aliphatic amino alcohols: Compounds having a linear or a branched hydrocarbon group of 1 to 20 carbon atoms, an amino group, and a hydroxyl group, such as monoamino isopentanol (in this specification, abbreviated as “AMB” in some cases) (NH₂(CH₂)₂CH(CH₃)CH₂OH) (molecular weight: 103).

Heterocyclic amino compounds: Compounds having a heterocyclic ring and an amino group, such as tetrahydrofurfuryl amine (in this specification, abbreviated as “FAM” in some cases) (structure represented by the following formula) (molecular weight: 101).

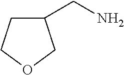

Amino acid compounds: Basic amino acid compounds, such as arginine (molecular weight: 174) and lysine (molecular weight: 146); amino acid compounds each having an amide group, such as asparagine (molecular weight: 132) and glutamine (molecular weight: 146); and other amino acid compounds, such as glycine (molecular weight: 75) and phenylalanine (molecular weight: 165).

Among those mentioned above, arginine (molecular weight: 174), lysine (molecular weight: 146), and histidine (molecular weight: 155), each of which is a basic amino acid, may be effectively used. In addition, as a peptide or a derivative thereof, for example, aspartame (molecular weight: 294), which is a methyl ester of a dipeptide of phenylalanine and asparaginic acid, may be effectively used.

Each of those low molecular weight amino compounds has in general a high water solubility, can be supplied in the form of a stable aqueous solution through a permeable membrane, and reacts with the carboxyl group of the membrane to bind to the permeable membrane as described above, thereby forming a water insoluble salt. Accordingly, holes formed by degradation of the membrane are filled up, and as a result, the rejection of the membrane is increased.

When the molecular weight of the low molecular weight amino compound used in the amino-treatment step of the present invention is more than 1,000, the low molecular weight amino compound may not be infiltrated into minute degraded portions in some cases. However, when the molecular weight of the amino compound is excessively small, the amino compound is difficult to stay at a dense layer of the membrane. Hence, the molecular weight of this amino compound is preferably 1,000 or less, more preferably 500 or less, and particularly preferably 60 to 300.

The low molecular weight amino compounds may be used alone, or at least two types thereof may be used in combination. When at least two types of low molecular weight amino compounds having different molecular weights and skeleton structures are used in combination and are simultaneously allowed to pass through a permeable membrane, the low molecular weight amino compounds interfere with each other when being allowed to pass through the membrane, and as a result, the residence time of each low molecular weight amino compound at degraded portions in the membrane is increased. Accordingly, the contact probability between the carboxyl group of the membrane and the amino group of the low molecular weight amino compound is increased, and hence, an effect of restoring the membrane is enhanced.

Hence, a low molecular weight amino compound having a molecular weight of several tens, such as approximately 60 to 300, and a low molecular weight amino compound having a molecular weight of several hundreds, such as approximately 200 to 1,000, are preferably used in combination, or a cyclic compound and a chain compound, and furthermore, a linear compound and a branched compound are preferably used in combination.

As preferable examples of the combination, besides combination between diamino benzoic acid and NMDA or IAAM, for example, combination between aniline and MODA, or combination between arginine and aspartame may be mentioned.

Although the concentration of the low molecular weight amino compound in the amino-treatment solution varies depending on the degree of degradation of the membrane, when the concentration is excessively high, the permeation flux may be decreased in some cases, and when the concentration is excessively low, the restoring may not be sufficiently performed in some cases. Hence, the concentration of the low molecular weight amino compound (or the total concentration of at least two types of low molecular weight amino compounds which are used in combination) in the amino-treatment solution is preferably 1 to 1,000 mg/L and more preferably approximately 5 to 500 mg/L.

When at least two kinds of low molecular weight amino compounds are used in combination, if the difference between the concentrations of the low molecular weight amino compounds is large, the effect achieved by the use of the low molecular weight amino compounds in combination is difficult to obtain; hence, the content of a low molecular weight amino compound contained at the lowest content is preferably set to 50% or more with respect to the content of a low molecular weight amino compound contained at the highest content.

In the amino-treatment step, those low molecular weight amino compounds in the form of an aqueous solution (excluding an aqueous solution having a pH of 7 or less) are passed through a permeable membrane.

In the amino-treatment step as described above, a tracer which may an inorganic electrolyte such as salt (NaCl), a neutral organic compound such as isopropyl alcohol or glucose, or a low molecular weight polymer such as a poly(maleic acid) can be added to the amino-treatment solution. When the tracer is added to the amino-treatment solution, the degree of restoring of the membrane can be confirmed by analysis of the degree of permeation of salt or glucose to water permeated through the permeable membrane.

Further the low molecular weight amino compound, the amino-treatment solution may contain a low molecular weight organic compound having a molecular weight of 1,000 or less, such as an alcoholic compound or a compound having a carboxyl group or a sulfonic group, in particular, isobutanol, salicylic acid, or a isothiazoline compound at a concentration of approximately 0.1 to 100 mg/L so as not to be polymerized with the low molecular weight amino compound. According to this, the steric hindrance at the dense layer is increased, whereby it is expected to enhance an effect of filling holes of the membrane.

The amino-treatment solution may contain further a polymer having a molecular weight of 1,000 to 10,000 and having a carboxyl group, an amino group, or a hydroxyl group. The polymer may be a tannic acid and a peptide. The tannic acid may be tannins extracted from plants, such as hydrolysable type sumac gallnut and gallnut and condensed type quebracho and mimosa. The peptide may be a polyglycine, a polylysine, a polytryptophan, or a polyalanine which has a molecular weight of 1,000 or more.

When a water supply pressure for passing the amino-treatment solution through a permeable membrane is excessively high, adsorption to non-degraded portions disadvantageously proceed. When the water supply pressure is excessively low, adsorption to degraded portions may not proceed. Hence, the water supply pressure is preferably set to 30% to 150% and particularly preferably 50% to 130% of a normal operation pressure for the permeable membrane.

This amino-treatment step may be performed at ordinary temperature such as at a temperature of approximately 10° C. to 35° C. The treatment time thereof depends on the concentration of a low molecular weight amino compound to be supplied. The upper limit of the treatment time is not particularly limited. However, the treatment time is, in general, preferably set to 0.5 to 100 hours and particularly preferably approximately 1 to 50 hours.

The amino treatment may be performed by adding an amino treatment agent to water to be treated during a normal operation of a permeable membrane apparatus. The time for adding the chemical agent may be approximately 1 to 500 hours. Instead thereof, the chemical agent may always be added. When the chemical agent is used in combination with a high molecular weight compound having a molecular weight of 1,000 to 10,000, the time is preferably approximately 1 to 200 hours.

When the permeation flux is reduced due to membrane contamination caused by a long-term operation, the chemical agent may be added after the membrane is cleaned by a chemical agent.

A chemical agent used for cleaning the membrane by acid may be an inorganic acid such as hydrochloric acid, nitric acid, or sulfuric acid, or an organic acid such as citric acid or oxalic acid. For alkaline cleaning sodium hydroxide or potassium hydroxide may be used. The pH may be set to approximately 2 in the acid cleaning, while in the alkaline cleaning, the pH may be set to approximately 12.

[Permeable Membrane]

The method for improving a rejection of a permeable membrane of the present invention may be preferably applied to a selective permeable membrane, such as a nanofiltration membrane or an RO membrane. The nanofiltration membrane is a liquid separation membrane for rejecting particles and a high molecular weight compound which have a particle diameter of approximately 2 nm or more. The nanofiltration membrane may be an inorganic membrane such as a ceramic membrane, or a polymer membrane which includes an asymmetric membrane, a composite membrane, and a charged membrane. The RO membrane is a liquid separation membrane in which a pressure higher than the difference in osmosis pressure between solutions separated by a membrane provided therebetween is applied to a higher concentration side so as to reject a solute and to allow a solvent to pass. The RO membrane may be a polymer membrane such as an asymmetric membrane, or a composite membrane. Materials for a nanofiltration membrane or an RO membrane to each of which the method for improving a rejection of a permeable membrane of the present invention is applied may be polyamide materials such as an aromatic polyamide, an aliphatic polyamide, and a composite material thereof; and cellulose materials such as a cellulose acetate. The method for improving a rejection of a permeable membrane of the present invention may be preferably applied to a permeable membrane which is formed from an aromatic polyamide material and which produces many carboxyl groups through breakage of the C—N bonds caused by degradation.

A module system of a permeable membrane to which the method for improving a rejection of a permeable membrane of the present invention is applied is not particularly limited, but may be a tubular membrane module, a planar membrane module, a spiral membrane module, and a hollow-fiber membrane module.

The permeable membrane of the present invention is a permeable membrane, such as a selective permeable membrane including an RO membrane or a nanofiltration membrane, treated by a rejection improving treatment using the method for improving a rejection of a permeable membrane of the present invention as described above. The rejection of the permeable membrane is improved in the state in which the permeation flux thereof is increased, and in addition, the state described above may be maintained for a long time.

[Water Treatment Method]

In a water treatment method of the present invention in which a permeable membrane treatment is performed using the permeable membrane of the present invention by allowing water to be treated to pass therethrough, the rejection of the permeable membrane may be increased in the state in which the permeation flux thereof is increased, and the state described above may be maintained for a long time, so that an effect of removing substances to be removed such as organic substances is high, and a stable treatment may be performed for a long time. Feeding and permeation operation of raw water to be treated may be performed in a manner similar to that of a normal permeable membrane treatment. A dispersant, a scale inhibitor, and/or other chemical agents may be added to raw water when the raw water contains hardness components such as calcium and/or magnesium. The water to be treated is not particularly limited, but the water may contain organic substances. The water may contain organic substances having a TOC of 0.01 to 100 mg/L and preferably approximately 0.1 to 30 mg/L. The water containing organic substances as described above may be wastewater from electronic device production works, wastewater from transport machinery production works, wastewater from organic synthesis works, wastewater from printing/plate making/painting works, or primary wastewater thereof. However, the water containing organic substances is not limited thereto.

### EXAMPLES

Hereinafter, with reference to Examples and Comparative Examples, the present invention will be described in more detail.

First, Comparative Examples 1 to 6 and Examples 1 to 6 will be described.

### Comparative Example 1

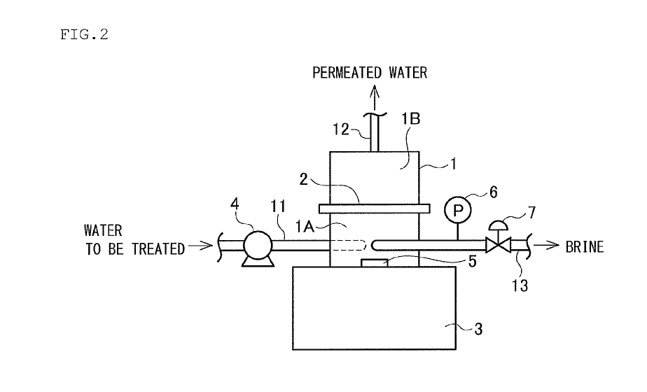

Water to be treated was passed through a flat membrane test device shown in FIG. 2 under the following conditions.

In this flat membrane test device, a flat membrane cell 2 was provided at an intermediate position in a height direction of a cylindrical container 1 having a bottom and a lid to partition the container into a raw water chamber 1A and a permeated water chamber 1B, and this container 1 was placed on a stirrer 3. While the water to be treated was supplied to the raw water chamber 1A by a pump 4 through a pipe 11, and the inside of the raw water chamber 1A was stirred by rotating a stirring bar 5 in the container 1, permeated water was extracted from the permeated water chamber 1B through a pipe 12and at the same time, brine was extracted from the raw water chamber 1A through a pipe 13. A pressure gauge 6 and a pressure regulation valve 7 were provided for the brine extracting pipe 13.

Degraded membrane: Ultra low pressure reverse osmosis membrane ES20 manufactured by Nitto Denko Corporation was rapidly degraded by immersion in a solution containing sodium hypochlorite (free chlorine: 1 mg/L) for 20 hours. The permeation flux, salt rejection, and IPA rejection of an original membrane were 0.81 m³/(m²·d), 97.2%, and 87.5%, respectively.

Water to be treated: NaCl 500 mg/L, IPA 100 mg/L

Operation pressure: 0.75 MPa

Temperature: 24° C.±2° C.

pH: 7.5 (controlled with an aqueous sodium hydroxide solution)

### Comparative Example 2

After the water was passed through the flat membrane test device under the same conditions as Comparative Example 1, and the degraded state was confirmed, water was passed under the same conditions as Comparative Example 1 except that the water was added with a tannic acid (403040-50G manufactured by Sigma-Aldrich Co. LLC) at a concentration of 0.5 mg/L and was controlled its pH at 7.5 with an aqueous sodium hydroxide solution.

### Comparative Example 3

After the water was passed through the flat membrane test device under the same conditions as Comparative Example 1, and the degraded state was confirmed, water was passed under the same conditions as Comparative Example 1 except that the water was added with a mimosa (manufactured by Dainippon Pharmaceutical Co., Ltd.) at a concentration of 0.5 mg/L and was controlled its pH at 7.5 with an aqueous sodium hydroxide solution.

### Comparative Example 4

After the water was passed through the flat membrane test device under the same conditions as Comparative Example 1, and the degraded state was confirmed, water was passed under the same conditions as Comparative Example 1 except that the water was added with poly(oxyethylene(10) oleyl ether) (manufactured by Wako Pure Chemical Industries, Ltd.) at a concentration of 0.5 mg/L and was controlled its pH at 7.5 with an aqueous sodium hydroxide solution, and that the water was passed for 2hours.

### Comparative Example 5

After the water was passed through the flat membrane test device under the same conditions as Comparative Example 1, and the degraded state was confirmed, water was passed under the same conditions as Comparative Example 1 except that water added with poly(ethylene glycol) (molecular weight: 4,000, manufactured by Wako Pure Chemical Industries, Ltd.) at a concentration of 1 mg/L was passed for 2 hours, and then water added with poly(oxyethylene(10) oleyl ether) (manufactured by Wako Pure Chemical Industries, Ltd.) at a concentration of 0.5 mg/L and controlled its pH at 7.5 with an aqueous sodium hydroxide solution was passed for 1 hours.

### Comparative Example 6

After the water was passed through the flat membrane test device under the same conditions as Comparative Example 1, and the degraded state was confirmed, water was passed under the same conditions as Comparative Example 1 except that water added with poly(vinyl amidine) at a concentration of 5 mg/L and controlled its pH at 7.5 with an aqueous sodium hydroxide solution for 2 hours, and then water added with poly(styrene sulfonic acid) to the water to be treated at a concentration of 5 mg/L was passed.

### Example 1

After the water was passed through the flat membrane test device under the same conditions as Comparative Example 1, and the degraded state was confirmed, water was passed under the same conditions as Comparative Example 1 except that water added with arginine at a concentration of 10 mg/L and controlled its pH at 7.5 with an aqueous sodium hydroxide solution was passed.

### Example 2

After the water was passed through the flat membrane test device under the same conditions as Comparative Example 1, and the degraded state was confirmed, water was passed under the same conditions as Comparative Example 1 except that water added with arginine at a concentration of 2 mg/L and controlled its pH at 7.5 with an aqueous sodium hydroxide solution was passed.

### Example 3

After the water was passed through the flat membrane test device under the same conditions as Comparative Example 1, and the degraded state was confirmed, water was passed under the same conditions as Comparative Example 1 except that water added with arginine and aspartame at concentrations of 2 mg/L and 1 mg/L, respectively, and controlled its pH at 7.5 with an aqueous sodium hydroxide solution was passed.

### Example 4

After the water was passed through the flat membrane test device under the same conditions as Comparative Example 1, and the degraded state was confirmed, water was passed under the same conditions as Comparative Example 1 except that water added with arginine, aspartame, and a tannic acid (403040-50G manufactured by Sigma-Aldrich Co. LLC) at concentrations of 2 mg/L, 1 mg/L, and 0.5 mg/L, respectively, and controlled its pH at 7.5 with an aqueous sodium hydroxide solution was passes for 24 hours.

### Example 5

After the water was passed through the flat membrane test device under the same conditions as Comparative Example 1, and the degraded state was confirmed, water was passed under the same conditions as Comparative Example 1 except that water added with arginine, aspartame, and mimosa (manufactured by Dainippon Pharmaceutical Co., Ltd.) at concentrations of 2 mg/L, 1 mg/L, and 0.5 mg/L, respectively, and controlled its pH at 7.5 with an aqueous sodium hydroxide solution was passed for 24 hours.

### Example 6

After the water was passed through the flat membrane test device under the same conditions as Comparative Example 1, and the degraded state was confirmed, water was passed under the same conditions as Comparative Example 1 except that water added with arginine, aspartame, and a quebracho (manufactured by Dainippon Pharmaceutical Co., Ltd.) at concentrations of 2 mg/L, 1 mg/L, and 0.5 mg/L, respectively, and controlled its pH at 7.5 with an aqueous sodium hydroxide solution was passed for 24 hours.

A permeation flux, salt rejection, and IPA rejection were calculated from the following equations.

Permeation flux [m³/(m²·d)]=permeation flux [m³/d]/membrane area [m²]·temperature conversion coefficient [−]

Salt rejection [%]=(1-conductivity of permeated water [mS/m]/conductivity of brine [mS/m])·100

IPA rejection [%]=(1-TOC of permeated water [mg/L]/TOC of brine [mg/L])·100

Improvement efficiency of the rejection was defined by the following equation.

Improvement efficiency of rejection [%/(m/d)]=improved rejection [%]/degraded permeation flux [m³/(m²·d)]

The results are shown in Table 1. It is understood that according to the present invention, the improvement efficiency of the rejection, in particular, the improvement efficiency of the IPA rejection, is significantly high.

TABLE 1
RESULTS IN TEST METHOD 1

| | DEGRADED | | | AFTER 2 HOURS OF | | | AFTER 24 HOURS OF |
|---|---|---|---|---|---|---|---|
| | STATE | | | WATER SUPPLY | | | WATER SUPPLY |
| | PERMEATION | SALT | IPA | PERMEATION | SALT | IPA | PERMEATION |
| | FLUX | REJECTION | REJECTION | FLUX | REJECTION | REJECTION | FLUX |
| | [m³/(m²d)] | [%] | [%] | [m³/(m²d)] | [%] | [%] | [m³/(m²d)] |
| ORIGINAL | 0.81 | 97.2 | 87.5 | | | | |
| COMPARATIVE | 0.91 | 91.8 | 78.2 | 0.90 | 91.8 | 78.2 | 0.89 |
| EXAMPLE1 | | | | | | | |
| COMPARATIVE | 0.90 | 92.0 | 78.7 | 0.88 | 93.8 | 81.0 | 0.86 |
| EXAMPLE2 | | | | | | | |
| COMPARATIVE | 0.91 | 91.4 | 78.4 | 0.89 | 93.0 | 81.3 | 0.85 |
| EXAMPLE3 | | | | | | | |
| COMPARATIVE | 0.92 | 90.6 | 77.8 | 0.68 | 95.2 | 91.1 | 0.68 |
| EXAMPLE4 | | | | | | | |
| COMPARATIVE | 0.92 | 90.5 | 77.9 | 0.77 | 94.3 | 88.7 | 0.72 |
| EXAMPLE5 | | | | | | | |
| COMPARATIVE | 0.91 | 91.5 | 78.5 | 0.82 | 93.0 | 82.1 | 0.80 |
| EXAMPLE6 | | | | | | | |
| EXAMPLE1 | 0.92 | 90.7 | 77.8 | 0.90 | 93.3 | 82.6 | 0.89 |
| EXAMPLE2 | 0.91 | 91.7 | 78.1 | 0.9 | 93.5 | 82.2 | 0.89 |
| EXAMPLE3 | 0.91 | 91.2 | 78.3 | 0.9 | 93.6 | 82.5 | 0.88 |
| EXAMPLE4 | 0.90 | 92.3 | 78.5 | 0.86 | 95.5 | 85.3 | 0.80 |
| EXAMPLE5 | 0.92 | 90.8 | 77.6 | 0.87 | 95.1 | 85.0 | 0.71 |
| EXAMPLE6 | 0.90 | 92.2 | 78.9 | 0.85 | 95.6 | 84.6 | 0.79 |

| | | | | | | IMPROVEMENT | |
|---|---|---|---|---|---|---|---|
| | AFTER 24 HOURS OF | | AFTER 96 HOURS OF | | | EFFICIENCY | |
| | WATER SUPPLY | | WATER SUPPLY | | | OF REJECTION | |
| | SALT | IPA | PERMEATION | SALT | IPA | SALT | IPA |
| | REJECTION | REJECTION | FLUX | REJECTION | REJECTION | REJECTION | REJECTION |
| | [%] | [%] | [m³/(m²d)] | [%] | [%] | [%] | [%] |
| ORIGINAL | | | | | | | |
| COMPARATIVE | 91.9 | 78.2 | 0.89 | 91.9 | 78.3 | 5.0 | 5.0 |
| EXAMPLE1 | | | | | | | |
| COMPARATIVE | 94.6 | 83.1 | 0.81 | 95.5 | 84.1 | 38.9 | 60.0 |
| EXAMPLE2 | | | | | | | |
| COMPARATIVE | 94.1 | 84.5 | 0.83 | 94.6 | 84.3 | 40.0 | 73.7 |
| EXAMPLE3 | | | | | | | |
| COMPARATIVE | 95.2 | 91.0 | 0.68 | 95.2 | 91.0 | 19.2 | 55.0 |
| EXAMPLE4 | | | | | | | |
| COMPARATIVE | 96.5 | 91.7 | 0.72 | 96.5 | 91.7 | 30.0 | 69.0 |
| EXAMPLE5 | | | | | | | |
| COMPARATIVE | 96.5 | 83.4 | 0.80 | 97.0 | 83.4 | 50.0 | 44.5 |
| EXAMPLE6 | | | | | | | |
| EXAMPLE1 | 94.9 | 85.0 | 0.88 | 95.0 | 85.1 | 107.5 | 182.5 |
| EXAMPLE2 | 94.3 | 84.6 | 0.87 | 95.6 | 85.3 | 97.5 | 180.0 |
| EXAMPLE3 | 94.7 | 85.0 | 0.86 | 95.9 | 85.7 | 94.0 | 148.0 |
| EXAMPLE4 | 98.6 | 90.2 | 0.80 | 98.6 | 90.2 | 63.0 | 117.0 |
| EXAMPLE5 | 97.7 | 91.2 | 0.81 | 97.7 | 91.2 | 62.7 | 123.6 |
| EXAMPLE6 | 98.2 | 90.3 | 0.79 | 98.2 | 90.3 | 54.5 | 103.6 |

Next, Comparative Examples 7 and 8 and Example 7 will be described.

### Comparative Example 7

Water to be treated was passed through the flat membrane test device shown in FIG. 2 under the following conditions.

Degraded membrane: Ultra low pressure reverse osmosis membrane ES20 manufactured by Nitto Denko Corporation was rapidly degraded by immersion in a solution containing sodium hypochlorite (free chlorine: 1 mg/L) for 30 hours.

Water to be treated: NaCl 500 mg/L, IPA 100 mg/L

Operation pressure: 0.75 MPa

Temperature: 24° C.±2° C.

pH: 7.2 (controlled with an aqueous sodium hydroxide solution)

### Comparative Example 8

After the water was passed through the flat membrane test device under the same conditions as Comparative Example 7, and the degraded state was confirmed, water was passed under the same conditions as Comparative Example 7 except that water added with a tannic acid (403040-50G manufactured by Sigma-Aldrich Co. LLC) at a concentration of 0.5 mg/L and controlled its pH at 7.2 with an aqueous sodium hydroxide solution was passed.

### Example 7

After the water was passed through the flat membrane test device under the same conditions as Comparative Example 7, and the degraded state was confirmed, water was passed under the same conditions as Comparative Example 7 except that water added with arginine, aspartame, and a tannic acid (403040-50G manufactured by Sigma-Aldrich Co. LLC) at concentrations of 2 mg/L, 1 mg/L, and 1 mg/L, respectively, and controlled its pH at 7.2 with an aqueous sodium hydroxide solution was passed for 24 hours.

The results are shown in Table 2. It is understood that according to the present invention, even by a reverse osmosis membrane having a degraded salt rejection of 90% or less, rejection improvement and restoring can be preferably performed.

TABLE 2
RESULTS IN TEST METHOD 2

| | DEGRADED | | | AFTER 2 HOURS OF | | | AFTER 24 HOURS OF |
|---|---|---|---|---|---|---|---|
| | STATE | | | WATER SUPPLY | | | WATER SUPPLY |
| | PERMEATION | SALT | IPA | PERMEATION | SALT | IPA | PERMEATION |
| | FLUX | REJECTION | REJECTION | FLUX | REJECTION | REJECTION | FLUX |
| | [m³/(m²d)] | [%] | [%] | [m³/(m²d)] | [%] | [%] | [m³/(m²d)] |
| COMPARATIVE | 0.98 | 85.3 | 70.6 | 0.98 | 85.3 | 70.6 | |
| EXAMPLE7 | | | | | | | |
| COMPARATIVE | 0.98 | 85.4 | 70.6 | 0.92 | 93.8 | 80.5 | 0.88 |
| EXAMPLE8 | | | | | | | |
| EXAMPLE7 | 0.98 | 85.3 | 70.6 | 0.90 | 95.4 | 86.3 | 0.88 |

| | | | | | | IMPROVEMENT | |
|---|---|---|---|---|---|---|---|
| | AFTER 24 HOURS OF | | AFTER 96 HOURS OF | | | EFFICIENCY | |
| | WATER SUPPLY | | WATER SUPPLY | | | OF REJECTION | |
| | SALT | IPA | PERMEATION | SALT | IPA | SALT | IPA |
| | REJECTION | REJECTION | FLUX | REJECTION | REJECTION | REJECTION | REJECTION |
| | [%] | [%] | [m³/(m²d)] | [%] | [%] | [%] | [%] |
| COMPARATIVE | | | | | | | |
| EXAMPLE7 | | | | | | | |
| COMPARATIVE | 95.1 | 82.1 | 0.86 | 95.2 | 82.5 | 81.7 | 99.2 |
| EXAMPLE8 | | | | | | | |
| EXAMPLE7 | 98.2 | 89.6 | 0.86 | 98.3 | 89.8 | 108.3 | 160.0 |

Next, Comparative Examples 9 and 10 and Examples 8 and 9 will be described.

### Comparative Example 9

Water to be treated was supplied to the flat membrane test device shown in FIG. 2 under the following conditions.

Commercially available membrane: Sea water desalination reverse osmosis membrane NTR-70SWC manufactured by Nitto Denko Corporation

Water to be treated: NaCl 30,000 mg/L, Boron 7 mg/L (addition in the form of boric acid)

Operation pressure: 6 MPa

Temperature: 24° C.±2° C.

pH: 8 (controlled with an aqueous sodium hydroxide solution)

### Comparative Example 10

Water was passed under the same conditions as Comparative Example 9 except that water added with poly(vinyl amidine) at a concentration of 5 mg/L was passed for 2 hours, and then water added with poly(styrene sulfonic acid) at a concentration of 5 mg/L and controlled its pH at 8 with an aqueous sodium hydroxide solution was passed for 2 hours.

### Example 8

Water was passed under the same conditions as Comparative Example 9 except that water added with arginine and aspartame at concentrations of 2 mg/L and 1 mg/L, respectively, and controlled its pH at 8 with an aqueous sodium hydroxide solution was passed.

### Example 9

Water was passed under the same conditions as Comparative Example 9 except that water added with arginine, aspartame, and a tannic acid (403040-50G manufactured by Sigma-Aldrich Co. LLC) at concentrations of 2 mg/L, 1 mg/L, and 0.5 mg/L, respectively, and controlled its pH at 8 with an aqueous sodium hydroxide solution was passed.

Boron rejection was calculated from the following equation.

Boron rejection [%]=(1-boron concentration in permeated water [mg/L]/boron concentration of brine [mg/L])·100

The results are shown in Table 3. It is understood that according to the present invention, even by a non-degraded reverse osmosis membrane, the rejection, in particular, the boron removal rate, can be improved without remarkably reducing the permeation flux. In Example 9, the rejection is most improved after 24 hours, and on the other hand, after 48 hours and 96 hours, the rejection was decreased. The reason for this is believed that since an excessive amount is adsorbed to the membrane surface, concentration polarization occurs. Accordingly, as a preferable treatment in Example 9, the rejection improving treatment by supply of the chemical agents is completed within 24 hours, and subsequently water supply is performed under conditions of Test 2.

TABLE 3
RESULTS IN TEST METHOD 3

| | AFTER 2 | | | AFTER 24 | | | AFTER 48 | | | AFTER 96 | | |
|---|---|---|---|---|---|---|---|---|---|---|---|---|
| | HOURS OF | | | HOURS OF | | | HOURS OF | | | HOURS OF | | |
| | WATER SUPPLY | | | WATER SUPPLY | | | WATER SUPPLY | | | WATER SUPPLY | | |
| | | | BO- | | | BO- | | | BO- | | | BO- |
| | PERME- | SALT | RON | PERME- | SALT | RON | PERME- | SALT | RON | PERME- | SALT | RON |
| | ATION | REJEC- | REJEC- | ATION | REJEC- | REJEC- | ATION | REJEC- | REJEC- | ATION | REJEC- | REJEC- |
| | FLUX | TION | TION | FLUX | TION | TION | FLUX | TION | ION | FLUX | TION | TION |
| | [m³/(m²d)] | [%] | [%] | [m³/(m²d)] | [%] | [%] | [m³/(m²d)] | [%] | [%] | [m³/(m²d)] | [%] | [%] |
| COMPAR- | 1.02 | 98.2 | 78.5 | 1.01 | 98.2 | 78.5 | 1.01 | 97.5 | 78.7 | 1.00 | 97.5 | 78.8 |
| ATIVE | | | | | | | | | | | | |
| EXAM- | | | | | | | | | | | | |
| PLE9 | | | | | | | | | | | | |
| COMPAR- | 0.91 | 98.9 | 82.1 | 0.88 | 99.2 | 84.3 | 0.88 | 99.2 | 84.4 | 0.89 | 99.2 | 84.3 |
| ATIVE | | | | | | | | | | | | |
| EXAM- | | | | | | | | | | | | |
| PLE10 | | | | | | | | | | | | |
| EXAM- | 1.00 | 98.5 | 88.7 | 0.98 | 98.7 | 89.8 | 0.97 | 98.9 | 90.6 | 0.97 | 99.0 | 90.8 |
| PLE8 | | | | | | | | | | | | |
| EXAM- | 0.96 | 98.6 | 91.1 | 0.92 | 99.2 | 92.3 | 0.91 | 99.2 | 92.2 | 0.88 | 99.2 | 90.0 |
| PLE9 | | | | | | | | | | | | |

As apparent from Examples and Comparative Examples described above, according to the present invention, when water supply is performed at a normal operation pressure by addition of the chemical agent to the water to be treated, while water is collected, the salt rejection can be recovered without remarkably reducing the amount of water permeated through the degraded membrane. In addition, the present invention can also be applied to a seriously degraded membrane having a salt rejection of 90% or less.

Although specific modes of the present invention have been described in detail, it is apparent to a person skilled in the art that various changes and modifications of the present invention may be carried out without departing from the concept and scope of the present invention.

In addition, this application claims the benefit of Japanese Patent Application No. 2011-051525 filed Mar. 9, 2011, which is hereby incorporated by reference herein in its entirety.

### REFERENCE SIGNS LIST

1 container

1A raw water chamber

1B permeated water chamber

2 flat membrane cell

3 stirrer

1. A method for improving a rejection of a permeable membrane, the method comprising a step of passing an aqueous solution (excluding an aqueous solution having a pH of 7 or less) containing a compound having an amino group and having a molecular weight of 1,000 or less through the permeable membrane.

2. The method for improving a rejection of a permeable membrane according to claim 1, wherein the compound having an amino group includes a basic amino acid.

3. The method for improving a rejection of a permeable membrane according to claim 1, wherein the compound having an amino group includes aspartame or a derivative thereof.

4. The method for improving a rejection of a permeable membrane according to claim 1, wherein the aqueous solution further contains a compound having a molecular weight of 1,000 to 10,000 and having a carboxyl group, an amino group, or a hydroxyl group.

5. The method for improving a rejection of a permeable membrane according to claim 4, wherein the compound having a molecular weight of 1,000 to 10,000 and having a carboxyl group, an amino group, or a hydroxyl group is a tannic acid or a polymer of an amino acid.

6. The method for improving a rejection of a permeable membrane according to claim 1, wherein the concentrations of the components of the compounds contained in the aqueous solution are each 10 mg/L or less.

7. A permeable membrane treated by a rejection improving treatment using the method for improving a rejection of a permeable membrane according to claim 1.

8. A treatment agent for improving a rejection of a permeable membrane, the treatment agent comprising at least one compound having a molecular weight of 1,000 or less and having an amino group and at least one compound having a molecular weight of 1,000 to 10,000 and having a carboxyl group, an amino group, or a hydroxyl group.

9. The treatment agent for improving a rejection of a permeable membrane according to claim 8, wherein the compound having an amino group is a basic amino acid.

10. The treatment agent for improving a rejection of a permeable membrane according to claim 8, wherein the compound having an amino group is aspartame or a derivative thereof.
